(19) United States
(12) Patent Application Publication
(10) Pub. No.: US 2020/0261185 A1
(43) Pub. Date: Aug. 20, 2020

(54) LIMITED WEAR ALIGNER AND TREATMENT METHODS

(71) Applicant: SmileDirectClub LLC, Nashville, TN (US)

(72) Inventors: Duane Daniel Hunter, Nashville, TN (US); John Dargis, Nashville, TN (US)

(21) Appl. No.: 16/280,739

(22) Filed: Feb. 20, 2019

(51) Int. Cl. A61C 7/08; A61C 7/00

(52) U.S. Cl. CPC A61C 7/08; A61C 9/004; A61C 7/002; A61C 7/008

(57) ABSTRACT

A method for orthodontic treatment includes providing an aligner configured to move a tooth of a user and providing a movement stimulus associated with the aligner where the movement stimulus is configured to move the tooth of the user substantially the same amount when the aligner is worn by the user less than twenty-two hours a day according to a treatment plan specifying a total number of treatment days than the aligner alone would be able to move the tooth when worn for at least twenty-two hours a day for the total number of treatment days.

### BACKGROUND

The present disclosure relates generally to dental aligners. More specifically, the present disclosure relates to dental aligners designed for limited-wear protocols.

Conventional dental aligners use a series of plastic trays to mechanically move the teeth of a user to a desired location over time. The plastic trays are custom made to fit tightly over the teeth to force the teeth to move to the desired location. Typical dental aligners require the user to wear the aligners for a significant amount of time each day (e.g., twenty-two hours per day) according to a treatment plan to achieve the desired results.

Despite the conventional recommended daily wear time, many users do not adhere to the recommended wear time and instead wear the aligners for less time, or even not at all some days. Some users may forget to put the aligners in before going out for the day or after brushing their teeth and before going to bed. Other users may choose not to wear the aligners during the day because they may feel the aligners alter the way they speak or sound to others. Other users may simply choose to stop using the aligners because the duration of the treatment is too long and they do not want to use the aligners any more.

An improved limited-wear aligner and treatment protocol is desirable to decrease the recommended daily wear time without diminishing the overall treatment effect.

### SUMMARY

According to one aspect of the disclosure, a method for orthodontic treatment includes providing an aligner configured to move a tooth of a user, and providing a movement stimulus associated with the aligner where the movement stimulus is configured to move the tooth of the user substantially the same amount when the aligner is worn by the user less than twenty-two hours a day according to a treatment plan specifying a total number of treatment days than the aligner alone would be able to move the tooth when worn for at least twenty-two hours a day for the total number of treatment days.

According to another aspect of the disclosure, a method for orthodontic treatment includes receiving 3-D images of a tooth of a user, generating a treatment plan for the user based on the images where the treatment plan specifies application of an aligner to the tooth for less than twenty-two hours per day, manufacturing the aligner based on the treatment plan where the aligner includes a movement stimulus configured to move the tooth of the user substantially the same amount than the aligner alone would be able to move the tooth when worn for at least twenty-two hours a day for the total number of treatment days, and providing the aligner to the user.

According to another aspect of the disclosure, an aligner includes an aligner configured to move a tooth of a user and a movement stimulus. The movement stimulus is configured to move the tooth of the user substantially the same amount when the aligner is worn by the user less than twenty-two hours a day according to a treatment plan specifying a total number of treatment days than the aligner alone would be able to move the tooth when worn for at least twenty-two hours a day for the total number of treatment days.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a top/occlusal view of a three-dimensional (3-D) model of teeth, according to some embodiments.

FIG. 2 is a flow diagram of a method for creating a dental aligner, according to some embodiments.

FIG. 3 is a diagram of a system for promoting movement of a user's teeth, according to some embodiments.

FIG. 4 is a top/occlusal view of a dental aligner, according to some embodiments.

FIG. 5 is a top/occlusal view of a dental aligner including a metal insert, according to some embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

A treatment plan using conventional dental aligners may require a user to wear the aligners for a substantial part of a day (e.g., twenty-two hours per day) for a predetermined number of months (e.g., eighteen months). However, some users may only desire to wear dental aligners when at home, or when sleeping. A user that wears the aligners less than an amount of time dictated by a treatment plan typically would not achieve the results desired by the treatment plan by the end of the treatment plan. Such a user may be more interested in utilizing a modified dental aligner that reduces wear time (e.g., daily wear time, number of days wearing the aligner).

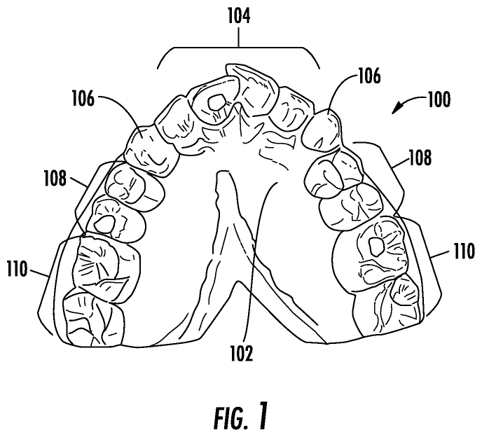

Referring to FIG. 1, a top/occlusal view of a 3-D model 100 of teeth 102 is shown, according to some embodiments. When users desire to realign their teeth, they may determine that the desired way to realign their teeth is by using dental aligners. In such cases, a 3-D model 100 of the user's teeth 102 is made. The 3-D model 100 can be created by scanning the teeth directly with a 3-D scanner, in which case the 3-D model 100 would be generated directly from the teeth of a user. Additionally or alternatively, a user may make impressions of their teeth 102 using an impression kit, and the impressions can then be scanned by a 3-D scanner to create the 3-D model 100.

The 3-D model 100 shows the locations of the incisors 104, the cuspids 106, the bicuspids 108, and the molars 110 at the time the teeth of the user are scanned. These locations are loaded into a computer, and the computer determines a treatment plan for moving the teeth of the user such that, after wearing the aligners according to the treatment plan, one or more of the teeth of the user are repositioned (e.g., to be straight).

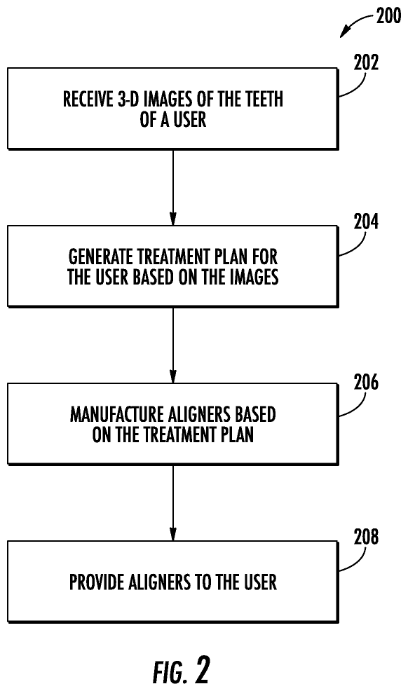

Referring now to FIG. 2, a flow diagram of a method for creating dental aligner is shown, according to some embodiments. At 202, 3-D images of the teeth of a user are received. In order for dental aligners to properly reposition the teeth of the user, an accurate model of the initial position of the teeth of the user must be generated. In some embodiments, the user may have access to a 3-D scanning system (e.g., by visiting a location associated with a manufacturer of dental aligners, using a mobile scanning system), and the 3-D scanning system is configured to scan the teeth of the user to create electronic images of the teeth of the user. In some embodiments, the user may not have access to a 3-D scanning system or prefer not to use such a system. In such cases, the user can create physical dental impressions of their teeth. For example, the impressions can be created by a professional in a professional office setting (e.g., at a dentist or orthodontist office). In another example, the impressions can be created by the user using a dental impression kit. After the user makes the impressions, the impressions can be scanned by 3-D scanner to create electronic images of the teeth of the user.

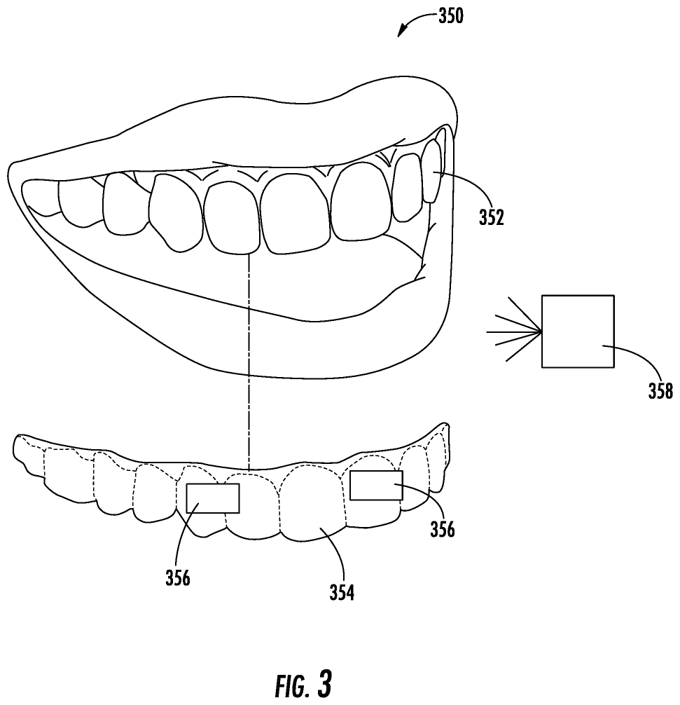

At 204, a treatment plan for the user is generated based on the images of the teeth of the user. After the 3-D images of the teeth of the user are received, a computer model of the teeth of the user is generated (e.g., the 3-D model 100). The computer model can include the 3-D images of the initial position of the teeth of the user. The computer model can also include the 3-D images of the desired final position of the teeth of the user. Based on the 3-D images of the initial position and desired final position of the teeth of the user, a treatment plan for the user can be created. Creating the treatment plan can include creating additional 3-D images of the teeth of the user to depict the incremental movement of the teeth during the treatment plan. from the initial position to the desired final position. The treatment plan can include using one or more aligners corresponding to the 3-D images of the teeth of the user to reposition the teeth of the user over the duration of the treatment plan. Additional treatment plan embodiments will be further described with reference to FIG. 3.

At 206, the aligners are manufactured based on the treatment plan. Any appropriate technique may be used to manufacture the aligners. For example, the aligners may be manufactured by 3D printing physical models of the teeth of the user based on the computer model, and then molding plastic aligners (e.g., by a thermoforming process) using the physical models.

At 208, the aligners are provided to the user. In some embodiments, multiple aligners may be distributed to the user in a single shipment. For example, the user may be sent all aligners required by the treatment plan, with instructions indicating the order that the aligners should be worn and the duration for each aligner to be worn. In another example, the user may be sent three aligners each month, with the first aligner to be worn for one week, the second aligner to be worn for one week, and the third aligner to be worn for two weeks.

Referring now to FIG. 3, a system 350 for promoting movement of a user's teeth is shown, according to some embodiments. As shown, the system 350 includes a dental aligner 354 configured to be worn over the user's teeth 352, an integrated light source 356, and an external light source 358. The dental aligner 354 can be manufactured based on the treatment plan.

In some embodiments, light therapy can be incorporated into the treatment method to aid in the movement of the teeth 352. Applying light to the teeth 352 and the surrounding gingival tissue and oral environment can have the effect of promoting bone remodeling and reducing pain, both of which can increase the movement velocity of the teeth 352 and promote a more consistent rate of tooth movement. The integrated light source 356 and the external light source 358 can include low level lasers, light emitting diodes (LEDs), near-infrared light, or any other light that can have the effect of increasing the movement velocity of teeth. Using such light therapy in combination with the treatment method may serve to increase the movement the velocity of the teeth, thereby reducing the wear time required to achieve the desired results. For example, a user can use a light therapy device that emits light at a wavelength of 850 nanometers. For example, using such a device for approximately ten minutes per day in conjunction with the aligner 300 can increase the movement velocity of the teeth 352, thereby reducing the overall treatment time.

In some embodiments, the dental aligner 354 includes the integrated light source 356 such that the integrated light source 356 provides the teeth 352 with light therapy. The integrated light source 356 may include any of the types of light described herein. In some embodiments, the integrated light source 356 turns on when the dental aligner 354 is placed over the teeth 352. In some embodiments, the integrated light source 356 may operate on a timer such that the light is emitted for duration according to the treatment plan. In some embodiments, the integrated light source 356 can be activated by a user (e.g., by touching the integrated light source 356 to activate the light).

In some embodiments, the dental aligner 354 does not include the integrated light source, and the light is provided to the teeth 352 and gingiva by the external light source 358. The external light source 358 may include any of the types of light described herein. In some embodiments, the external light source 358 is used when the user is not wearing the dental aligner 354. In some embodiments, the external light source is used when the user is wearing the dental aligner 354. In some embodiments, the external light source 358 operates on a timer such that the light is applied to the teeth 352 and gingiva for the for a duration according to the treatment plan.

In some embodiments, the treatment can include both the dental aligner 354 with the integrated light source 356 and the external light source 358. In some embodiments, the light from the integrated light source 356 can be applied to the teeth 352 and the gingiva at the same time as the light from the external light source 358. In some embodiments, the light from the integrated light source 356 can be applied to the teeth 352 at a different time than the light from the external light source 358. In some embodiments, the type of light from the integrated light source 356 is different than the type of light from the external light source 358. For example, the integrated light source 356 can be a low-level laser and the external light source 358 can be an LED. In some embodiments, the integrated light source 356 is an optical element that receives and reflects light from the external light source 358. While the external light source 358 is shown to be external from a mouth of the user, it will be appreciated that the external light source 358 can be positioned at least partially within the user's mouth during operation. For example, the external light source 358 can be a mouth guard that is configured to be worn by the user separate from the dental aligner 354 or while the user is also wearing the dental aligner 354.

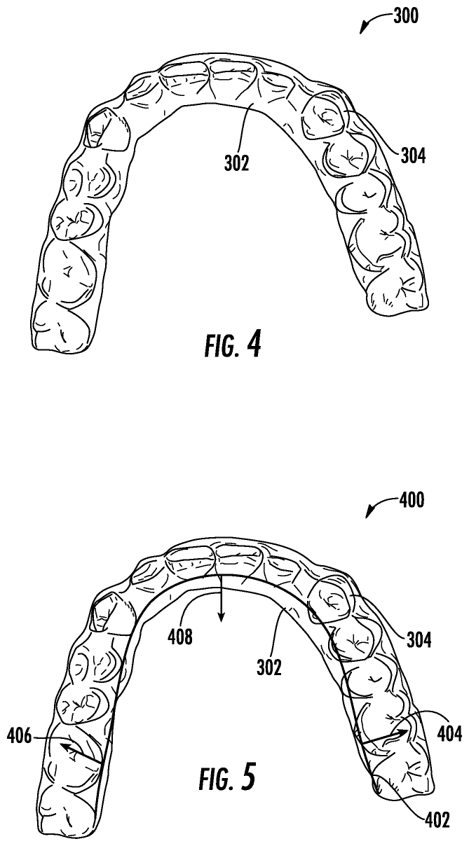

Referring now to FIG. 4, a top/occlusal view of a dental aligner 300 is shown, according to some embodiments. As shown, the dental aligner 300 does not include any performance enhancing structures (e.g., such as the metal 402 of the aligner of FIG. 4), and can be either one of the first, last, or intermediate aligners worn by the user to move the user's teeth to the desired location according to the treatment plan. The dental aligner 300 can be manufactured based on the treatment plan.

To achieve the desired results by wearing the aligners for a reduced time, the physical properties of the aligners may be modified. Conventional aligners are typically constructed from a plastic material that tends to lose its elasticity over time such that the shape of the aligner after the user wears it is different than the shape of the aligner before the user wears it. This is one of the reasons a recommended wear time can be twenty-two hours per day and the treatment duration can be more than a year. To reduce the recommended wear time without significantly changing the overall treatment duration, the material of aligner 300 can be modified. In some embodiments, modifying the aligner 300 can change the overall treatment plan generated at step 204.

In some embodiments, the thickness of the material of the aligner 300 can be increased to prevent the aligner 300 from losing its elasticity over time. The material itself may not change, but the aligner 300 can be made thicker with the same material as it is conventionally made. The thicker material would resist losing its elasticity over time more than a thinner material. The thicker material may also exert a higher force on the teeth of the user such that the teeth move at a higher velocity when compared to an aligner not made with a thicker material. In some embodiments, the thickness of the material of the aligner 300 can vary across the aligner 300 such that thicker sections of the aligner 300 may be more resistant to permanent deformation than thinner sections. In such embodiments, varying the thickness of the material of the aligner 300 can create variable, non-constant forces (or non-constant force directions) on the teeth.

For example, the thickness of the material of the aligner 300 can be variable such that when the aligner is worn by a user a variable, non-constant force is applied to a first tooth and a non-variable, constant force is applied to a second tooth. In another example, the thickness of the material of the aligner 300 can be variable such that when the aligner is worn by a user a non-constant force direction is applied to a first tooth (e.g., applying force to the first tooth initially in a first direction and then applying force to the first tooth in a second direction) and a constant force direction is applied to a second tooth.

In some embodiments, the physical structure of the material of the aligner 300 can be modified to prevent the aligner 300 from permanently deforming under load. In some embodiments, the material of the aligner 300 can be a honeycomb structure (e.g., an array of hollow cells formed between solid walls). In other embodiments, the material of the aligner 300 can be corrugated (e.g., transverse ripples formed between solid walls). In some embodiments, the material of the aligner 300 can be a lattice-type structure (e.g., an array of interconnected struts formed between solid walls).

In some embodiments, the material of the aligner 300 may be modified to make the material less elastic. To make the material of the aligner 300 less elastic, antiplasticizers can be added to the material. Antiplasticizers can have the effect of increasing the modulus of elasticity of a material, making the material maintain its original shape or to make the material less likely to permanently deform when under load. With antiplasticizers included in the material of aligner 300, the likelihood of the aligner 300 to deform when under load from the teeth 352 is lower. In some embodiments, the addition of antiplasticizers to the material of aligner 300 can be combined with making the material of aligner 300 thicker, thereby decreasing the elasticity of aligner 300 and increasing the velocity of the movement of the teeth 352. Examples of antiplasticizers include tricresyl phosphate and dibutylphthalate. Using antiplasticizers alone, or in combination with a thicker material, can allow aligner 300 to move the teeth 352 in such a way as to decrease the required wear time per day while not significantly increasing the overall duration of treatment. In some embodiments, antiplasticizers can be incorporated into the material of the aligner 300 in a homogeneous manner such that the modulus of elasticity of the aligner 300 is consistent throughout the aligner 300. In some embodiments, antiplasticizers can be incorporated into the material of the aligner 300 in a non-homogeneous manner. For example, the incisors 104 may need to move more than the molars 110 over the treatment duration. To cause greater movement of the incisors 104, antiplasticizers can be incorporated into the aligner 300 only in the area of the incisors 104. In this way, the incisors 104 can move with a greater velocity than the molars 110. In another example, antiplasticizers can be incorporated into the aligner in the area of the incisors 104, but only on the lingual side 302 of the aligner 300. The combination of a higher modulus of elasticity on the lingual side 302 and a traditional modulus of elasticity on the buccal side 304 of the aligner 300 can cause the incisors 104 to move with a greater velocity than if the aligner 300 had a homogeneous modulus of elasticity in the area of incisors 104.

In some embodiments, the aligner 300 can be modified such that the surface of the aligner 300 that is in contact with the teeth 352 exhibits a high amount of friction (e.g., any relative motion between the aligner 300 and the teeth 352 can be added, increased, reduced or eliminated). By modifying the relative motion between the aligner 300 and the teeth 352, the movement of the teeth 352 can be more accurate and consistent, thereby reducing the wear time required to achieve the desired results. In some embodiments, the frictional surface can be imparted to the aligner 300 by physically roughening the surface of the aligner 300 that contacts the teeth 352 (e.g., by using a tool or other material to roughen the desired surface). In some embodiments, the frictional surface can be imparted to the aligner 300 by chemically roughening the surface of the aligner 300 that contacts the teeth 352 (e.g., by using a chemical to roughen the desired surface). In some embodiments, both the lingual surface 302 and the buccal surface 304 of the aligner 300 is roughened. In other embodiments, only one of the lingual surface 302 or the buccal surface 304 of the aligner 300 is roughened.

Referring now to FIG. 5, a top/occlusal view of a dental aligner 400 is shown, according to some embodiments. The dental aligner 400 can be manufactured based on the treatment plan. In some embodiments, the aligner 400 can be modified such that an additional mechanical advantage is added to the material of the aligner 400. In some embodiments, the dental aligner 400 includes the integrated light source 356 of the dental aligner 354. Adding an additional mechanical advantage can serve to increase the overall elasticity of the aligner 400, thereby reducing the wear time required to achieve the desired results. In some embodiments, the overall elasticity of the aligner is increased (e.g., by using a honeycomb, corrugated, or lattice structure) so that the aligner has shape memory, such that the shape of the aligner can change while the aligner is worn and return to its original shape or substantially its original shape when not being worn. In some embodiments the additional mechanical advantage can be achieved by adding a reinforcement 402 to the lingual surface 302 of the aligner 400. The reinforcement 402 can be added to any surface of the aligner 400 (e.g., buccal, occlusal, front, bottom, and top).

The reinforcement 402 may be a metal material. Metals typically have a higher modulus of elasticity than plastics, therefore incorporating a metal reinforcement 402 into the aligner 400 increases the overall modulus of elasticity of the aligner 400 and aids in increasing the movement velocity, consistency, and predictability of the teeth 352, in addition to increasing the duration of the force on the teeth 352. Metals that may be incorporated into the aligner 400 as the reinforcement 402 include both non-shape memory alloys and shape memory alloys. A non-shape memory alloy has a limited or reduced ability to undergo deformation and return to its pre-deformation shape. Non-shape memory alloys include metals such as stainless steel and aluminum, and other metals typically used in a setting within the human body. Non-shape memory alloys can help the aligner 400 resist deformation by increasing the overall modulus of elasticity of the aligner 400.

A shape memory alloy has the ability to undergo deformation and return to its pre-deformation shape. Shape memory alloys include metals such as nickel-titanium (Nitinol), and copper-aluminum-nickel. A shape memory alloy can be used to do more than resist deformation of the aligner 400, like the non-shape memory metals. A shape memory metal could also be shaped such that when the aligner 400 is inserted over the teeth 352, the shape memory metal applies additional forces to the teeth 352 to promote more efficient movement of the teeth 352. This can be accomplished by heat treating different sections of the shape memory alloy in different ways according to known methods. In some embodiments, the shape memory alloy may be programmed using heat treatment methods to exert an external force on the molars 110, indicated by arrows 404 and 406, and an internal force, indicated by arrow 408, on the incisors 104. Using a shape memory alloy in this way can increase the movement velocity and movement precision of the teeth 352, thereby reducing the wear time required to achieve the desired results.

In some embodiments, the reinforcement 402 can be a plastic material. The plastic material used as the reinforcement 402 may have a higher modulus of elasticity than the plastic material used for the aligner 400, thereby increasing the overall modulus of elasticity of the aligner 400. Examples of a plastic reinforcement 402 include acrylonitrile butadiene styrene (ABS), polyurethane, polycarbonate, and polyethylene. The plastic material used as the reinforcement 402 may also include a shape memory plastic (e.g., linear block copolymers, cross-linked copolymers, and light induced shape memory polymers).

In some embodiments, vibration can be incorporated into the treatment method to aid in the movement of the teeth 352. Vibrating teeth for a short period of time each day can have the effect of stimulating cellular activity in the blood around the teeth such that the mouth is more susceptible to movement of the teeth. In this way, the velocity of the teeth can be increased, thereby reducing the wear time required to achieve the desired results. Such vibration can be achieved by using an available vibration device to stimulate the teeth prior to, during, or after wearing the aligner 300. For example, a vibration device worn by a user can provide vibrational forces of approximately 0.25 Newton's at a frequency of approximately thirty Hertz. A user that wears such a device for approximately twenty minutes per day prior to or while wearing a dental aligner according to a treatment plan can achieve the result of increasing the movement velocity of the teeth 352, thereby reducing the overall treatment time.

In some embodiments, chemical therapies can be incorporated into the treatment method to aid in the movement of teeth. Certain chemicals have been shown to increase the velocity of the movement of teeth. Non-limiting examples of these chemicals include vitamin D and prostaglandins. Other chemicals have been shown to decrease the velocity of the movement of teeth. Non-limiting examples of these chemicals include bisphosphonates, fluorides, and estrogen. In some embodiments, chemicals can be injected into the gum tissue near a certain tooth to either accelerate or inhibit the movement of the tooth. For example, the incisors 104 may need to move a significant amount relative to the molars 110. In such a case, a chemical that increases the velocity of tooth movement can be injected in the gums near the incisors 104, and a chemical that decreases the velocity of tooth movement can be injected in the gums near the molars 110. The movement of the incisors 104 can thus be increased relative to the movement of the molars 110 in such a way that would not be possible by using a conventional aligner alone.

In some embodiments, the chemicals that can increase or decrease tooth movement can be embedded in, attached to, surrounded by, applied to, or otherwise on, the aligner 300 such that the aligner 300 can slowly release the chemicals over time. In some embodiments, the chemicals that can increase or decrease tooth movement can be applied to the aligner 300 such that the teeth 352 are in contact with the chemicals. In this way, the chemicals would interact directly with the teeth and either accelerate or inhibit the movement accordingly.

In some embodiments, the modifications to the aligner 300 and the overall treatment method can be incorporated as standalone modifications. In some embodiments, the modifications to the aligner 300 and the overall treatment method can be used in combination with each other. For example, a treatment method may provide ten aligners to a user. The first aligner can be a traditional aligner, made with a traditional material and traditional material thickness so the user can acclimate to wearing an aligner. The second aligner can include a thicker material combined with antiplasticizers to increase the modulus of elasticity of the aligner and increase the movement velocity of the teeth.

The third aligner can include antiplasticizers and a frictional surface to contact the teeth, along with instructions for the user to use a vibration device for twenty minutes each day. The fourth aligner can include a shape memory metal along the lingual surface of the aligner, along with instructions to use a light therapy device for ten minutes each day while wearing the aligner.

The fifth aligner can include an instruction to receive a chemical injection, where the user could visit a professional to inject chemicals at different locations in the mouth of the user to facilitate or inhibit the movement of specific teeth or groups of teeth. The fifth aligner can also include thicker material in the areas in which movement is facilitated by the chemical injection and thinner material in the areas in which movement is inhibited by the chemical injecti on.

The sixth aligner can include a traditional aligner with instructions to use a vibration device for thirty minutes per day and a light therapy device for twenty minutes per day. The seventh aligner can include a non-shape memory metal along the lingual surface of the aligner combined with a frictional surface along the buccal surface of the aligner. Instructions included with the seventh aligner may instruct the user to use a vibration device for twenty minutes per day.

The eighth aligner can include a composite of metals along the lingual surface of the aligner. For example, the aligner may include shape memory metals along the lingual surfaces of the molars and a non-shape memory metal along the lingual surface of the incisors, cuspids, and bicuspids to facilitate different movement velocities between the different groups of teeth.

The ninth aligner can include antiplasticizers and instructions to the user to use a light therapy device for ten minutes per day. The tenth and final aligner can include a thicker material and additional chemical injections to facilitate the final positioning of the teeth of the user.

It will be appreciated that any of the embodiments disclosed herein can be combined with one another. For example, the treatment plan can dictate, and an aligner created based on the treatment plan can include, the use of the integrated light source 356, the external light source 358, material having a variable thickness, material preventing the aligner from permanently deforming under load, the use of antiplasticizers, an additional mechanical advantage (e.g., the reinforcement 402), and any other feature disclosed herein.

As utilized herein, the term “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary,” “example,” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the Figures. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above.

It is important to note that the construction and arrangement of the systems, apparatuses, and methods shown in the various exemplary embodiments is illustrative only. Additionally, any element disclosed in one embodiment may be incorporated or utilized with any other embodiment disclosed herein. For example, any of the exemplary embodiments described in this application can be incorporated with any of the other exemplary embodiment described in the application. Although only one example of an element from one embodiment that can be incorporated or utilized in another embodiment has been described above, it should be appreciated that other elements of the various embodiments may be incorporated or utilized with any of the other embodiments disclosed herein.

1. A method for orthodontic treatment, the method comprising:
providing a plurality of aligners to a user, the plurality of aligners configured to move a first tooth of the user, wherein the user applies at least one of the plurality of aligners to the first tooth for less than twenty-two hours per day during a treatment duration;
wherein each aligner of the plurality of aligners includes a movement stimulus configured to affect movement of the first tooth of the user, the plurality of aligners including a first aligner that includes a first movement stimulus, a second aligner that includes a second movement stimulus, a third aligner that includes a third movement stimulus, and a fourth aligner that includes a fourth movement stimulus;
wherein the third movement stimulus and the fourth movement stimulus are the same, and wherein the first movement stimulus, the second movement stimulus, and the third movement stimulus comprises using different thicknesses of a material of the plurality of aligners.

2. The method of claim 1, wherein the aligners are configured to exert variable, non-constant forces on the first tooth.

3. The method of claim 1, wherein the aligners are configured to exert variable, non-constant force directions on the first tooth.

4. The method of claim 1, wherein the aligners are configured to exert variable non-constant forces or force directions on the first tooth.

5. The method of claim 4, wherein the aligners are configured to exert a first force on the first tooth in a first direction and a second force on a second tooth in a second direction, the first direction being different from the second direction.

6. The method of claim 5, wherein the first force is greater than the second force.

7. The method of claim 5, wherein the first force is a variable, non-constant force.

8. The method of claim 6, wherein the second force is a variable, non-constant force.

9. A method for orthodontic treatment, the method comprising:
receiving 3-D images of a tooth of a user;
generating a treatment plan for the user based on the images, the treatment plan specifying application of a plurality of aligners to the tooth, the plurality of aligners including a first aligner, a second aligner, and a third aligner;
manufacturing the plurality of aligners based on the treatment plan, each aligner of the plurality of aligners including a movement stimulus configured to move the tooth of the user, wherein the first aligner includes a first movement stimulus, the second aligner includes a second movement stimulus, and the third aligner includes a third movement stimulus, the first movement stimulus being different from at least one of the second movement stimulus and the third movement stimulus, wherein the first movement stimulus comprises a first thickness of a material of the plurality of aligners, the second movement stimulus comprises a second thickness of the material, and the third movement stimulus comprises the second thickness of the material; and
providing the plurality of aligners to the user, wherein the user applies at least one of the plurality of aligners to the tooth for less than twenty-two hours per day.

10. (canceled)

11. The method of claim 9, wherein the first movement stimulus comprises one of a shape memory alloy embedded in the first aligner, a light coupled to the first aligner, a vibration device coupled to the first aligner, a chemical applied to the first aligner, an antiplasticizer embedded in the first aligner, a frictional surface on the first aligner, the first thickness, and a first non-constant thickness of a wall of the first aligner.

12. The method of claim 9, wherein the second movement stimulus comprises one of a shape memory alloy embedded in the second aligner, a light coupled to the second aligner, a vibration device coupled to the second aligner, a chemical applied to the second aligner, an antiplasticizer embedded in the second aligner, a frictional surface on the second aligner, the second thickness, and a second non-constant thickness of a wall of the second aligner.

13. The method of claim 12, wherein the third movement stimulus comprises one of a shape memory alloy embedded in the third aligner, a light coupled to the third aligner, a vibration device coupled to the third aligner, a chemical applied to the third aligner, an antiplasticizer embedded in the third aligner, a frictional surface on the third aligner, the second thickness, and a third non-constant thickness of a wall of the third aligner.

14. The method of claim 9, the plurality of aligners further comprising a fourth aligner having a fourth movement stimulus, the fourth movement stimulus being the same as the third movement stimulus.

15. The method of claim 14, wherein the treatment plan comprises applying the first aligner to the tooth for a first duration, applying the second aligner to the tooth for a second duration, applying the third aligner to the tooth for a third duration, and applying the fourth aligner to the tooth for a fourth duration.

16. The method of claim 15, wherein the first duration, the second duration, the third duration, and the fourth duration are the same.

17. An aligner system comprising:
a plurality of aligners configured to move a tooth of a user, wherein the user applies at least one of the plurality of aligners to the tooth for less than twenty-two hours per day during a treatment duration, a first aligner of the plurality of aligners including a first thickness of a material, a second aligner of the plurality of aligners including a second thickness of the material, and a third aligner of the plurality of aligners including a third thickness of the material, and wherein the first aligner imparts a first movement stimulus to the tooth via the first thickness, the second aligner imparts a second movement stimulus to the tooth via the second thickness, and the third aligner imparts a third movement stimulus to the tooth via the third thickness, wherein the first thickness is greater than either the second thickness or the third thickness.

18. The aligner system of claim 17, wherein at least one of the first movement stimulus imparted by the first aligner and the second movement stimulus imparted by the second aligner includes a vibration device removably coupled to the aligner.

19. The aligner system of claim 18, wherein the treatment plan specifies wearing the vibration device for at least twenty minutes per day.

20. The aligner system of claim 18, wherein the vibration device is configured to stimulate a cellular activity around the tooth to make the tooth more susceptible to move in response to forces imparted to the tooth by the aligner.

21. The aligner system of claim 17, wherein at least one of the first movement stimulus imparted by the first aligner and the second movement stimulus imparted by the second aligner comprises a chemical applied to at least one of the tooth, the first aligner, and the second aligner.

22. The aligner system of claim 17, wherein at least one of the first movement stimulus imparted by the first aligner and the second movement stimulus imparted by the second aligner comprises a light device configured to apply light to the tooth.

23. The aligner system of claim 17, wherein at least one of the first movement stimulus imparted by the first aligner and the second movement stimulus imparted by the second aligner comprises a non-constant thickness of a wall of at least one of the first aligner and the second aligner, the non-constant thickness configured to apply variable, non-constant forces or force directions to the tooth.

24. The aligner system of claim 17, wherein at least one of the first movement stimulus imparted by the first aligner and the second movement stimulus imparted by the second aligner comprises a frictional surface on at least one of the first aligner and the second aligner, the frictional surface configured to contact the tooth to prevent the tooth from slipping within at least one of the first aligner and the second aligner.
